(19) United States
(12) Patent Application Publication
(10) Pub. No.: US 2012/0053863 A1
(43) Pub. Date: Mar. 1, 2012

(54) System for Fossil Fuel Byproduct Management.

(76) Inventors: Clay Edward Slade, North Logan, UT (US); Clayton R. Carter, North Logan, UT (US); Janos Imre Lakatos, Mendon, UT (US); Jacob L. Rippstein, Providence, UT (US); James T. Kelsey, Nibley, UT (US); Eric Raymond John, Nibley, UT (US)

(21) Appl. No.: 13/177,256

(22) Filed: Jul. 6, 2011

Related U.S. Application Data
(63) Continuation-in-part of application No. PCT/US10/46838, filed on Aug. 26, 2010.

(51) Int. Cl. G06F 19/00

(52) U.S. Cl. 702/55

(57) ABSTRACT

A system for fossil fuel byproduct management is claimed which includes a computer for receiving and recording volume measurements of one or more fossil fuel liquid byproducts among a plurality of fossil fuel liquid byproducts located within a storage container and a transmitter operable by the computer to transmit the volume measurements to a data collection location. A method of use for the same, which includes monitoring byproduct volumes and recording information relating to releases is also claimed.

### CROSS-REFERENCE TO RELATED APPLICATIONS

This application is a continuation-in-part of, and claims priority from, International Application No. PCT/US 10/46838, filed on Aug. 26, 2010, currently pending, and incorporated herein by reference.

### TECHNICAL FIELD OF THE INVENTION

This invention relates to a system for fossil fuel byproduct management. The present invention relates particularly to an apparatus including a computer for, among other functions, receiving and recording volume measurements of one or more fossil fuel liquid byproducts among a plurality of fossil fuel liquid byproducts located within a storage container and a transmitter, among other functions, operable by the computer to transmit said volume measurements to a data collection location. The invention also includes a method using of the above.

### BACKGROUND OF THE INVENTION

Production of primary fossil fuels at a well site often entails production of a number of secondary materials or fossil fuel byproducts. As one of many possible examples, natural gas wells produce water and condensate. These byproducts are often temporarily stored together in the same container at a well site, pending removal by a transport vehicle to another location for disposal or further processing. The value of byproducts in temporary storage may vary widely. For example, at natural gas wells, produced water has a relatively low market value and is often just moved off-site for disposal. However, condensates have a relatively high market value as hydrocarbons and they are often subsequently moved off-site for further processing or sale.

One reality of fossil fuel production is that lessors or other responsible entities may be ill equipped to monitor the removal and custody transfer of valuable fossil fuel byproducts from temporary storage. Temporary storage may be located in harsh climates or remote areas and monitoring may be technologically impractical and/or economically unfeasible. Given those circumstances, misappropriation of valuable byproducts frequently occurs by entities in the transport chain or others. Such problems directly affect the public when lessors or other responsible entities are government or tribal agencies charged with managing and optimizing resources for the public trust and benefit.

Additionally, many traditional methods for attempting to ascertain amounts of valuable byproduct released to a transport vehicle are frequently unsafe and inaccurate. Referring again to natural gas well production as an example, transport vehicle operators or others may attempt to measure condensate in a water-condensate mixture by manually placing measuring sticks or other items into storage containers, thereby creating dangerous exposure to flammable and hazardous materials.

Although some systems for facilitating custody transfer of fossil fuels are known in the art, there is a dearth of resilient, low maintenance, versatile, and economical systems that can remain at a well site to monitor and track custody transfer of fossil fuel liquid byproducts for a given location, then record and transmit relevant data elsewhere.

### BRIEF SUMMARY OF THE INVENTION

In accordance with the above, a new and innovative system for fossil fuel byproduct management is provided. The present invention may address one or more of the problems discussed above. For example, the problem of tracking fossil fuel byproducts at a well-site is solved by an apparatus including a computer for receiving and recording volume measurements of one or more fossil fuel liquid byproducts among a plurality of fossil fuel byproducts located within a storage container and a transmitter operable by the computer to transmit said volume measurements to a data collection location, as well as a method of use for the same.

### BRIEF DESCRIPTION OF THE SEVERAL VIEWS OF THE DRAWINGS

FIG. 1 is an overview of one embodiment of the invention at a storage container.

FIG. 2a is a view of the housing, storage container user interface, display, and valve of one embodiment of the invention.

FIG. 2b is a cross-section view of the valve of one embodiment of the invention.

FIG. 2c is a view of an actuator for the valve of one embodiment of the invention.

FIG. 3a is a view of the sensing means of various embodiments of the invention.

FIG. 3b is a view of the sensing means of various embodiments of the invention.

FIG. 4 is a block diagram of the computer and transmitter in one embodiment of the invention.

FIG. 5 is a flow chart of one embodiment of a method using the invention.

FIG. 6 is a view of one embodiment of the invention that includes a gas monitor.

### DETAILED DESCRIPTION OF THE INVENTION

The present invention in its various embodiments, some of which are depicted in the figures herein, is a system for fossil fuel byproduct management. While certain aspects of the prior art may be discussed herein, applicants in no way disclaim technical aspects or features that may be related to or disclosed in the prior art. Furthermore, nothing stated herein is necessarily prior art as it relates to the specific invention set forth.

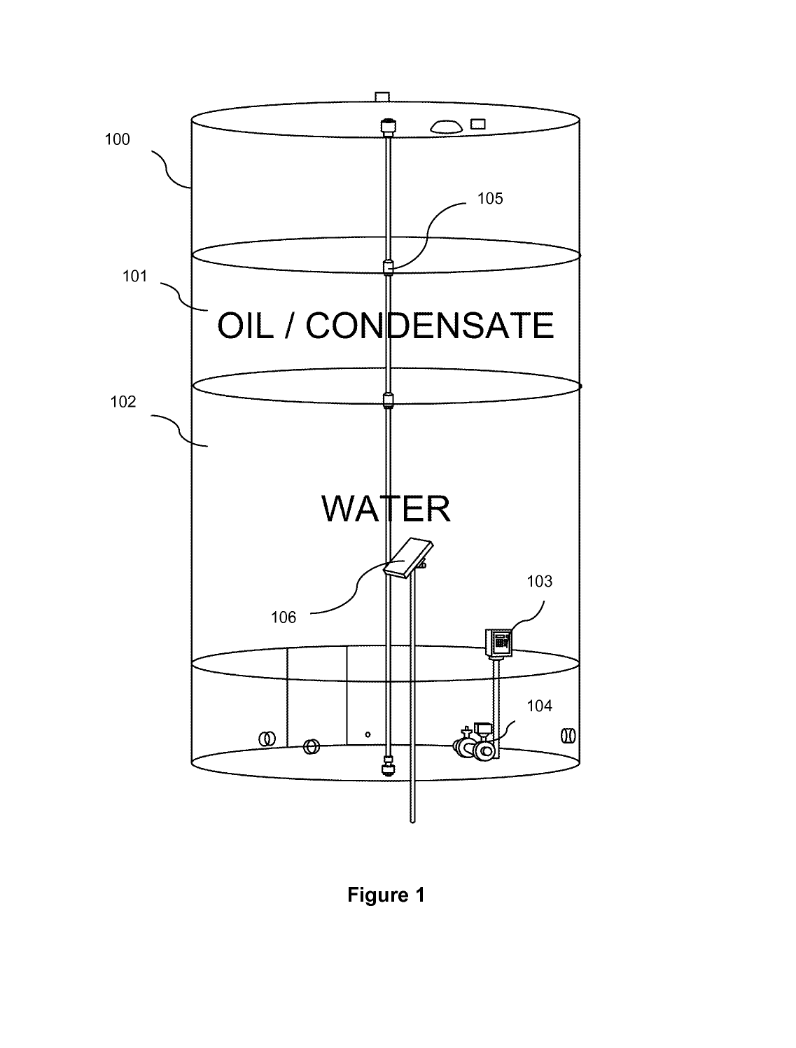

FIG. 1 is a broad overview of one embodiment of the apparatus underlying the invention at a storage container environment [100]. A storage container [100] holds one or more fossil fuel liquid byproducts among a plurality of fossil fuel byproducts within a storage container. In FIG. 1, the storage container [100] is depicted as containing oil or condensate [101] and water [102] as fossil fuel liquid byproducts. As depicted, the oil or condensate is known to naturally separate from water as a result of differing fluid density. Notwithstanding FIG. 1, it is known that the storage container may contain different fossil fuel liquid byproducts, including, but not limited to, diesel fuel and/or oil In various embodiments of the invention, housing [103] encloses a computer and transmitter (not shown).

Some embodiments of the invention include a valve [104] capable of automated and/or manual operation, typically located adjacent to a volume of fossil fuel liquid byproduct or byproducts within a storage container [101, 102]. In various embodiments, the valve is connected to and operable by the computer to release a quantity of one or more fossil fuel liquid byproducts among a plurality of fossil fuel liquid byproducts located within a storage container [100] to a transport vehicle. The valve [104] may be connected to the computer in the housing [103] through wired or wireless means.

Various embodiments of the invention may include a solar panel [106] used with a battery for powering the computer, transmitter, and/or other components of the invention as described herein. The battery may be located in the housing [103] and the solar panel may be connected to the battery by wired or other means. Various embodiments of the invention may also include a sensing means [105] for making volume measurements of one or more fossil fuel liquid byproducts among a plurality of fossil fuel liquid byproducts located within a storage container [100]. Various embodiments of the invention may monitor one or more byproducts, other embodiments two or more byproducts, and so on. The sensing means [105] may be connected to the computer in the housing [103] through wired or wireless means.

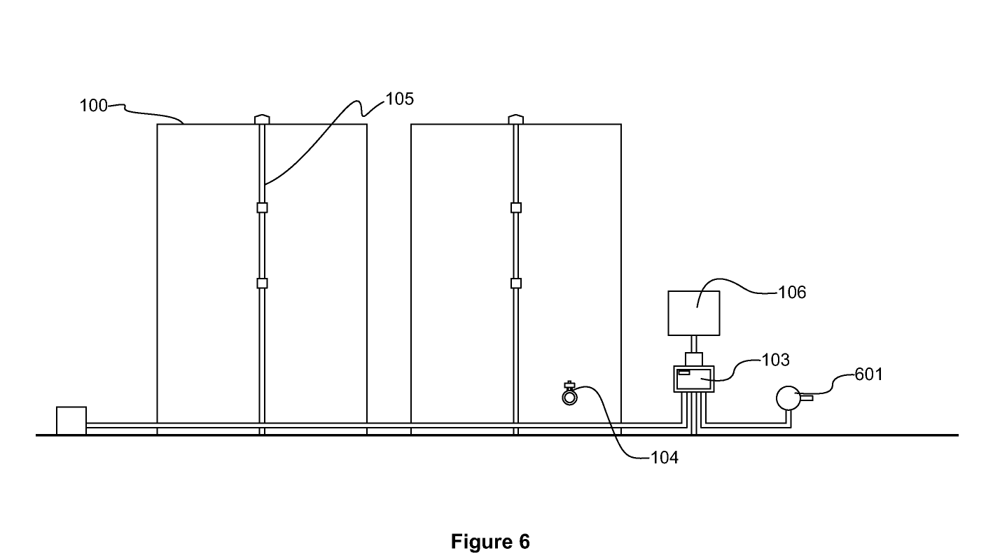

FIG. 6 also shows a broad overview of one embodiment of the invention at a storage container environment [100]. Some embodiments of the invention include one or more gas monitors [601] for monitoring the levels of one or more gasses in a storage container environment. Gas monitors may use catalytic, electrochemical, and/or infrared gas detection methods, among others. Monitored gasses may include, but are not limited to acetylene, ammonia, arsine, bromine, carbon dioxide, carbon monoxide, chlorine, chlorine dioxide, methane, natural gas, petroleum vapors, diborane, ethylene oxide, fluorine, hydrogen fluoride, hydrogen, hydrogen chloride, hydrogen cyanide, hydrogen sulfide, nitric oxide, nitrogen dioxide, oxygen, phosphine, silane, and sulfur dioxide. The monitor [601] is typically located external to a storage tank and may be connected to the computer in the housing [103] through wired or wireless means.

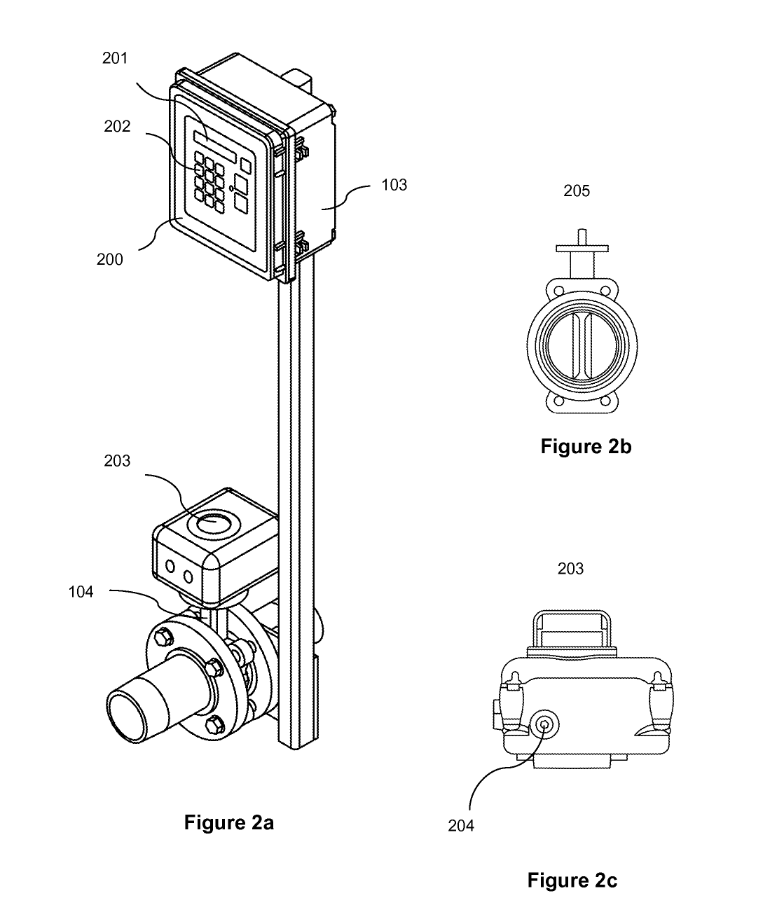

FIG. 2a is an exterior view of the computer and transmitter housing together with the automated valve of one embodiment of the invention. In various embodiments of the invention, a housing [103] made of any number of durable and weather-resistant materials, including metal, plastic, rubber, or other polymer, encloses the computer and transmitter, along with other applicable components of the invention. The housing [103] is constructed to be tight and water and dust resistant. For example the housing may incorporate a sealing system comprised of gaskets and bolts. The housing [103] is typically located outside of and adjacent to a storage container [100].

Various embodiments of the invention include a storage container user interface [200] that is connected to the computer, and that allows a user to run routines, access programs or modes of the computer, or accomplish other functions. The storage container user interface [200] may be connected to the computer through wired or wireless means. The interface may include a display [201] connected to the computer for displaying program steps, modes, or status of the computer's operation. In various embodiments of the invention, LCD technology is used for the display, although other types of displays may be used. Various embodiments of the invention also include a numeric or alphanumeric keypad [202] to assist users in running routines, accessing features and programs of the computer, or accomplishing other functions. The keypad [202] may include various keys to enter a sequence of numbers or letters for processing, to turn the display on or off, to initiate or stop a transaction (such as a release), or to indicate the status of a valve as described below. The storage container user interface [200] may include any number of different configurations and technology types.

Some embodiments of the invention include a valve [104] that is capable of automated and/or manual operation. The valve [104] is located adjacent to a volume of one or more fossil fuel liquid byproducts among a plurality of fossil fuel liquid byproducts located within a storage container [100] such that opening the valve facilitates the release of a quantity of one or more fossil fuel liquid byproducts. More particularly, in various embodiments of the invention, additional valves may be located upstream or downstream of the valve such that the additional valves must also be opened to achieve release of a quantity of liquid byproduct. FIG. 2b depicts one embodiment of a cross-section view of the valve [205] which is of a simple butterfly type design. It is known however, that a variety of different valve types may be used in connection with the invention.

In one embodiment of the invention, an automated version of the valve may include an electric actuator [203] with one or more switches that are capable of being controlled by the computer through wired or wireless connections to open a seated butterfly valve. Such a product is available from ABZ VALVE.™ However, it is known that there are a number of equivalent valves and actuators, and any number of automated and/or manual valve types may be used. In various embodiments, electric actuators or other powered components of the valve [104] may be powered in connection with the solar panel [106] depicted in FIG. 1.

In various embodiments of the invention, the valve [104] includes a means for being opened manually. For example, FIG. 2c shows an allen or hex wrench/key receptacle [204] in the electric actuator [203] of the valve [104] which may be used to open the valve [104] manually. It is known that there are a number of equivalent structures and designs to open the valve [104] manually, and any number of these structures and designs may be used in the invention. For example, hand wheels, levers, or pedals, among other manual opening means, may be used.

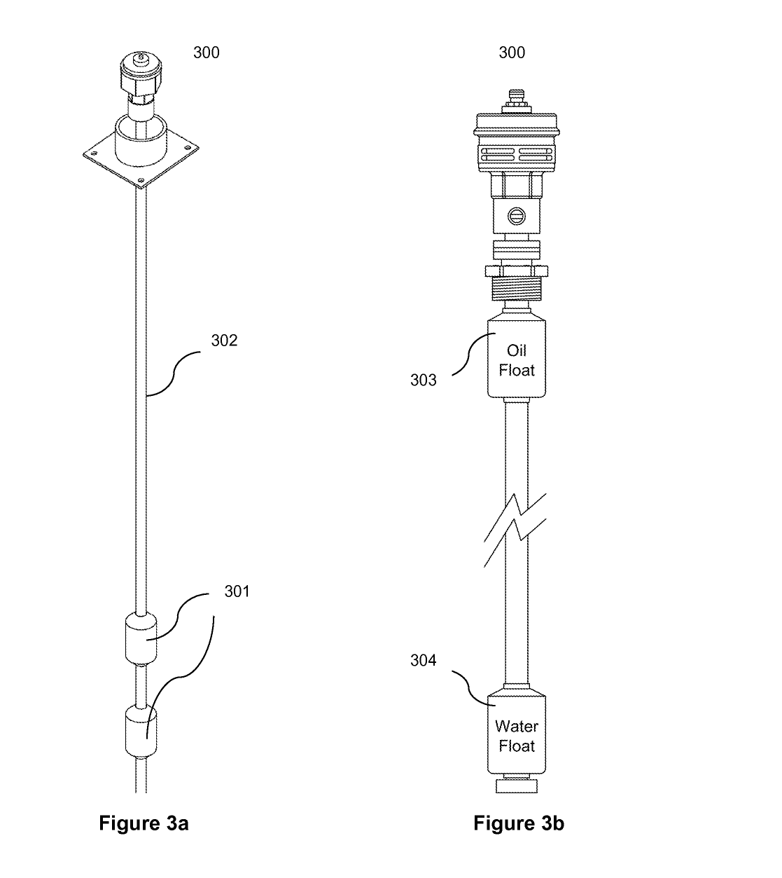

Referring now to FIGS. 3a and 3b, various embodiments of the invention may include a sensing means for making volume measurements of one or more fossil fuel liquid byproducts among a plurality of fossil fuel liquid byproducts located within a storage container. A variety of equivalent sensors are known in the art and suitable to measure fluid in a storage container, including level sensors, ultrasonic sensors, or pressure transducers or gauges. Where two or more byproducts of varying density are located together within a single storage tank, a dual float-type sensor [300] may be used to monitor volumes of different byproducts simultaneously. One embodiment of the invention utilizes a dual float sensor made by APG®. This sensor incorporates floats of differing density [301] mounted along a single rod [302]. The densities of the floats correspond to the densities of different byproducts. For example, FIG. 3b depicts floats for oil [303] and water [304]. The dual float sensor [300] uses a magnetostrictive wire to sense the position of a magnet mounted in the floats. The sensor may also measure fossil fuel liquid byproduct temperature through a thermometer. The sensor may be connected to the computer through wired or wireless connections. It is known that a variety of different dual float-type or other sensors may be used with the invention to accomplish its purpose.

In various embodiments, the valve, sensing means, and solar panel, all connect to the housing with uniquely keyed “quick-connect” receptacles which preclude a person from easily connecting these components incorrectly. Accordingly, removal of these components for maintenance or replacement is fast and simple and technical expertise is not required.

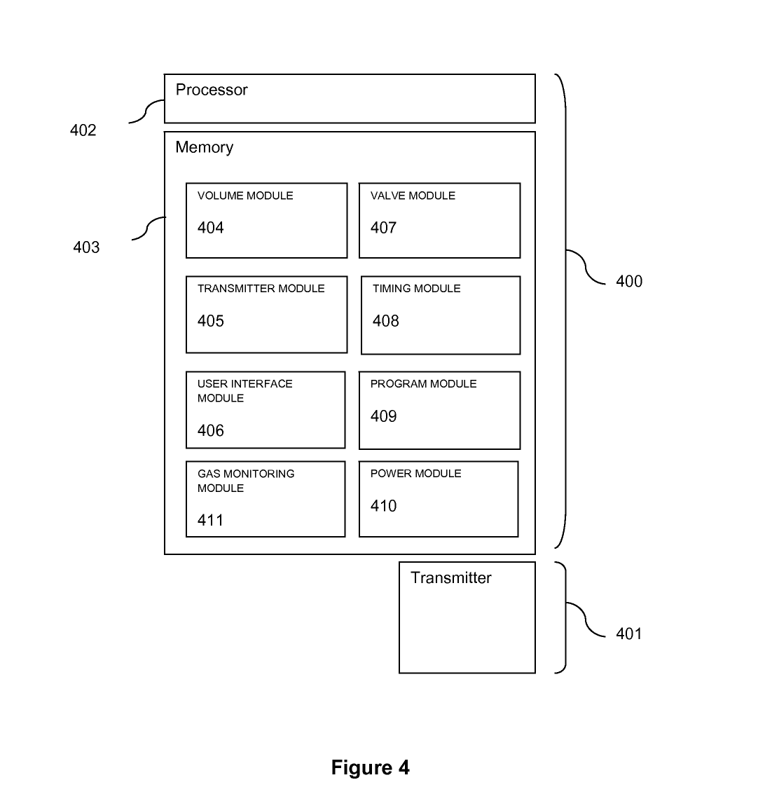

FIG. 4 is a block diagram of the computer [400] and transmitter [401] in one embodiment of the invention. In various embodiments, the computer [400] is an embedded special purpose computer with a processor [402] coupled to memory [403] and programmed to perform a variety of tasks to facilitate fossil fuel byproduct management. Such tasks may include, but are not limited to, one or more of the following: receiving and recording volume measurements of fossil fuel liquid byproducts; detecting releases; and transmitting information related to measurements and releases to a data collection location and monitoring gas. In many embodiments of the invention, the embedded computer is located at the storage container and is adjacent to the transmitter. Locating the computer in this manner optimizes data transmission because the on-site and embedded computer is able to first package the data prior to transmission elsewhere.

The computer [400] is in communication with a transmitter [401] through either wired or wireless means. The type of transmitter used varies across embodiments, but may include an RFID transmitter and/or reader, any number of devices—including cellular telephone—that utilize GSM or SMS technology, or any other devices allowing for network communication. One skilled in the art will recognize that the transmitter [401] may be selected from among many suitable technologies. In various embodiments, the transmitter [401] may also be capable of data reception or two-way communication. In certain embodiments of the invention, the transmitter is configured with multiple transmission means thereby achieving a redundancy that ensures that data is transmitted and that the system can be used in many different parts of the world which may have varying types of transmitter technologies. For example, one embodiment of the invention incorporates both GSM and RFID technology into the transmitter.

In various embodiments, the memory [403] of the computer [400] may store a volume module [404] containing instructions to receive and store or record volume measurements of one or more fossil fuel liquid byproducts among a plurality of fossil fuel liquid byproducts located within a storage container [100]. In connection with the sensor described above, the volume module may contain instructions to receive and store or record volume measurements simultaneously for different byproduct types among a plurality of byproducts located within a storage container. The volume module [404] may include program instructions to direct the processor [402] to initiate volume measurements upon command by a user, at predetermined temporal intervals, and/or when new volume levels are detected such as may occur when a quantity of byproduct has been added to or released from a storage container. The volume module [404] may contain instructions to assign and record a source identifier—which is any designation that uniquely identifies a well site and/or storage container—and volume value for one or more fossil fuel liquid byproducts among a plurality of fossil fuel liquid byproducts located within a storage container to a release of a quantity of one or more of the byproducts to a transport vehicle. In various embodiments, the source identifier may correspond to an API well number or other specific well name.

In various embodiments, memory [403] of the computer [400] may store a transmitter module [405] to facilitate the exchange of information between the computer [400], the transmitter [401], and a data collection location or locations. A data collection location may be adjacent to the storage container or it may be off-site. A data collection location may also be an RFID tag located on a transport vehicle. The transmitter module [405] may store instructions to direct the processor to operate the transmitter [401] to send volume measurements to a data collection location or locations. The transmitter module [405] may store instructions to direct the processor to operate the transmitter [401] to transmit to a data collection location or locations the source identifier and volume value for one or more fossil fuel liquid byproducts among a plurality of fossil fuel liquid byproducts located within a storage container corresponding to a release of a quantity of one or more of the byproducts to a transport vehicle. In various embodiments, the transmitter module [405] may store instructions to direct the processor to transmit many different types of information, including, but not limited to: the start and stop time of a release of fossil fuel liquid byproduct; volume values for one or more fossil fuel liquid byproducts among a plurality of fossil fuel liquid byproducts located within a storage container immediately preceding release; volume values for one or more fossil fuel liquid byproducts among a plurality of fossil fuel liquid byproducts located within a storage container immediately following release; byproduct temperature, storage container temperature; battery voltage; error codes; gas levels; source identifiers etc.

The transmitter module [405] may also contain instructions for directing the processor [422] to receive information through the transmitter [401]. For example, in various embodiments, the transmitter module [405] may receive information from a data collection location. Such information may include, but is not limited to, identification information corresponding to a transport vehicle or the operator of a transport vehicle as well as access permission information or security codes which may facilitate the opening of an automated valve to release a quantity of byproduct or byproducts to a transport vehicle. The transmitter module [405] may also have instructions for allowing an off-site user to access and/or instruct the computer from an off-site location through a network connection.

In various embodiments, memory [403] of the computer [400] may contain a user interface module [406] for allowing a user to communicate with the computer [400] through a storage container user interface. The user interface module [406] may have instructions to direct the processor [402] to process input obtained from a user through a keypad and to display information through a display. The user interface module [406] may contain instructions to direct the processor [402] to display various information including, but not limited to: volume measurements of fossil fuel liquid byproduct or byproducts; amounts of byproduct released to a transport vehicle; the status of the computer [400], including any error messages corresponding to malfunctions in the operations of the computer and/or the components it may operate, including valves; and/or gas levels

In various embodiments, memory [403] may contain a valve module [407] for operating an automated valve. The valve module [407] may have instructions that direct an automated valve to open in response to input at the storage container user interface keypad. For example, in one embodiment, the valve may open when a user pushes a “START” button, and close when a user pushes a “STOP” button. In various embodiments, the valve module [407] may have instructions to direct the processor to close the automated valve if the valve is opened manually. This function minimizes spills if a valve is left open.

In various embodiments, memory [403] may contain a timing module [408] with a real time clock to track time and date. The timing module [408] may contain instructions to create timestamps of events such as volume measurements and releases and/or gas levels.

Various embodiments of the invention may include a program module [409] for accomplishing a variety of tasks [403], including through the use of one or more other modules named herein. For example, various embodiments of the invention contain instructions which allow a user to select times or intervals at which volume or gas measurements will be made and/or transmitted to a data collection location. This feature allows lessors or other responsible entities to constantly monitor valuable fossil fuel liquid byproduct or byproducts in a storage container. The feature also allows for the monitoring of dangerous gasses in the vicinity of a storage container.

Also, various embodiments of the program module [409] contain instructions to record and/or transmit information relating to a release of a quantity of one or more fossil fuel liquid byproducts among a plurality of fossil fuel liquid byproducts located within a storage container to a transport vehicle. Specifically, in one embodiment of the invention, a program receives a predetermined numeric or alphanumeric code for identifying an entity initiating a release of a quantity of one or more byproducts to a transport vehicle. This code may be received through a keypad on a storage container user interface or through the transmitter using RFID, GMS, SMS, or any number of other types of communication. The predetermined code may correspond to the operator of the transport vehicle, the transport vehicle, and/or the owner of the transport vehicle. After the code is received, the program then records the code with a corresponding volume value for one or more fossil fuel liquid byproducts among a plurality of fossil fuel liquid byproducts located within a storage container and source identifier for a release and transmits the code, value or values, and identifier to a data collection location. In various embodiments, the program module [409] records a value or values and identifier for a release and transmits the same to a data collection location even when the predetermined code is not received or when an invalid code is received. Accordingly, the invention allows lessors or other responsible entities to identify entities conducting releases or to be notified of any and all releases of fossil fuel liquid byproduct. In certain embodiments of the invention, the program module [409] may contain instructions to store the recorded code with a corresponding volume value or values and source identifier for a release after any transmission of that data to a data collection location. This ensures protection against data loss if there is a problem at the data collection location as it allows for data access in the immediate vicinity of the storage container.

In various embodiments, the program module [409] contains instructions to use the predetermined numeric or alphanumeric code for a security function. Specifically, use of the automated valve to initiate a release may be preconditioned on correct input or verification of the predetermined numeric or alphanumeric code. The program module [409] may have instructions to close the automated valve in the event that it is opened manually and/or through unauthorized access. In various embodiments, measuring volume of a byproduct or byproducts in a storage container may be preconditioned on correct input of the predetermined numeric or alphanumeric code. In certain embodiments the program module [409] contains instructions to authorize predetermined release quantities for one or more fossil fuel liquid byproducts among a plurality of fossil fuel liquid byproducts located within a storage container to a transport vehicle. In such embodiments, the predetermined release quantities correspond to the predetermined code for identifying a releasing entity. Accordingly, in such embodiments, different releasing entities have varying access levels to the byproducts in a storage container.

Various embodiments of the invention may include a power module [410] for managing the power supply of the invention. The power module [410] may contain instructions to operate the computer, transmitter, and/or powered valve components in such a way as to minimize power consumption until input is performed at the storage container user interface or instructions connected to the timing module [408] require the performance of functions that consume relatively larger amounts of power.

In various embodiments, the memory [403] of the computer [400] may store a gas monitoring module [411] containing instructions to receive and store or record independent measurements of one or more gasses in the vicinity of the storage container. The gas monitoring module [411] may include program instructions to direct the processor [402] to initiate measurements of one or more gasses upon command by a user, at predetermined temporal intervals, and/or when new gas levels are detected such as may occur when byproduct or byproducts have been added to or released from a storage container. In various embodiments, the memory of the computer may assign a source identifier to measurements of one or more gasses. Also, in various of the embodiments, one or more of the above features may be combined with the computer to receive and record volume measurements of byproducts located in a plurality of storage containers.

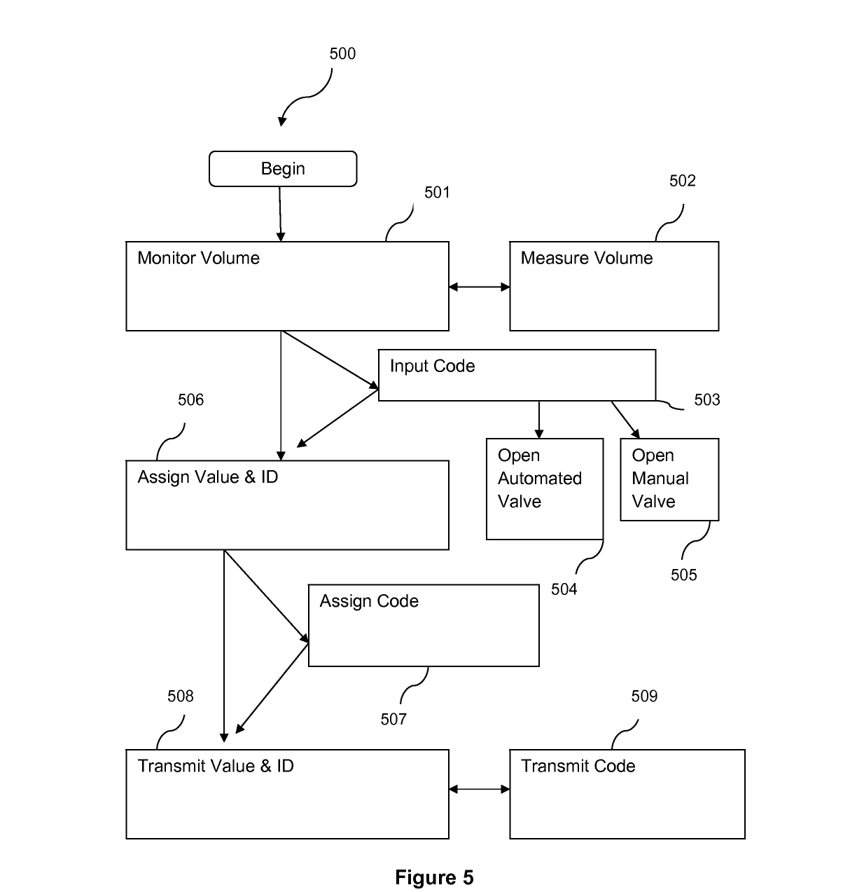

FIG. 5 depicts one embodiment of a method for fossil fuel byproduct management using the apparatus relating to the invention. The method [500] may begin by monitoring the volume of one or more fossil fuel liquid byproducts among a plurality of fossil fuel liquid byproducts located within a storage container using the computer disclosed herein [501]. Monitoring may include, but is not limited to, initiating volume measurements upon command by a user, conducting volume measurements at predetermined temporal intervals, or detecting or recording new volume levels, such as may occur when byproduct has been added to or released from a storage container. Monitoring may also include receiving transmissions related to the aforementioned information. Monitoring may include actions performed at a well site, including through the storage container user interface, or it may include actions performed remotely through network or other communication. Various embodiments of the method also include the alternative step of conducting the volume measurement of one or more fossil fuel liquid byproducts among a plurality of fossil fuel liquid byproducts located within a storage container using the sensing means disclosed herein [502], in connection with the computer.

Various embodiments of the method also include the step of inputting a predetermined code into the computer [503]. As set forth above, the predetermined code identifies an entity initiating a release of a quantity of one or more byproducts to a transport vehicle. In various embodiments, the operator of a transport vehicle may enter this code through a keypad at the storage container interface. In various embodiments, the code may be received through the transmitter of the apparatus and may originate at a data collection location such as an RFID tag. In some embodiments of the invention, the correct entry of the predetermined code may allow the operator of a transport vehicle to operate an automated valve [504] to release a quantity of one or more byproducts to a transport vehicle. In one embodiment, the valve may be opened when a user pushes a “START” button, and may be closed when a user pushes a “STOP” button on the keypad at the storage container user interface. Alternatively, the operator of a transport vehicle may use manual means to open the valve [505].

The next step in the method is made by the computer's assigning a volume value and source identifier to a release of a quantity of one or more fossil fuel liquid byproducts among a plurality of fossil fuel liquid byproducts located within a storage container to a transport vehicle. Various embodiments of the method also include the step of assigning and/or recording the predetermined code or other information to the release [507], together with the volume value and source identifier. Other information may include: the start and stop time of a release; volume value or values for a byproduct or byproducts immediately preceding release; volume value or values for a byproduct or byproducts immediately following release; byproduct temperature, storage container temperature; battery voltage, error codes, etc.

The next step in the method is transmitting the volume value and source identifier to a data collection location using the computer and transmitter disclosed herein [508]. Various embodiments of the method also include the step of transmitting the predetermined code and/or other information together with the volume value and source identifier corresponding to a release [509].

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

What is claimed is:

1. An apparatus for fossil fuel liquid byproduct management comprising:
a computer with memory for receiving and recording volume measurements of one or more fossil fuel liquid byproducts among a plurality of fossil fuel liquid byproducts located within a storage container and storing modules for program control and manipulating data in memory; and
a transmitter operable by the computer to transmit said volume measurements to a data collection location.

2. The apparatus of claim 1, the transmitter further operable by the computer to send the volume measurements to a data collection location at predetermined temporal intervals.

3. The apparatus of claim 1, the computer further capable of recording a release of a quantity of the one or more fossil fuel liquid byproducts to a transport vehicle with a source identifier and volume value for the one or more liquid byproducts corresponding to the release.

4. The apparatus of claim 3, the transmitter further operable by the computer to transmit to a data collection location the source identifier and volume value for the one or more liquid byproducts for a release of a quantity of the one or more byproducts to a transport vehicle.

5. The apparatus of claim 4, the computer further operable to receive a predetermined code for identifying an entity initiating the release of a quantity of the one or more byproducts to a transport vehicle.

6. The apparatus of claim 5, the computer further operable to record the code with a corresponding volume value for the one or more byproducts and a source identifier for a release; said computer further operable to transmit the code, volume value, and source identifier to a data collection location by using the transmitter.

7. The apparatus of claim 6, the computer further located at the storage container and capable of optimizing data prior to transmission.

8. The apparatus of claim 1 the computer and the transmitter further located within a water tight and dust impermeable housing adjacent to and outside of the storage container.

9. The apparatus of claim 1, further comprising a solar panel and battery for powering the computer and transmitter.

10. The apparatus of claim 1, further comprising a display connected to the computer for displaying program steps and modes of the computer's operation.

11. The apparatus of claim 1, further comprising a sensing means for making volume measurements of the one or more byproducts.

12. The apparatus of claim 6, the computer further capable of storing the recorded code with a corresponding volume value for the one or more byproducts and source identifier for a release after any transmission of the same to a data collection location.

13. The apparatus of claim 1, the computer further capable of receiving and recording volume measurements of byproducts located in a plurality of storage containers.

14. An apparatus for fossil fuel liquid byproduct management comprising:
a computer with memory for receiving and recording volume measurements of one or more fossil fuel liquid byproducts among a plurality of fossil fuel liquid byproducts located within a storage container and storing modules for program control and manipulating data in memory; the computer further capable of recording a release of a quantity of the one or more byproducts to a transport vehicle with a source identifier and volume value for differing byproducts corresponding to the release; and
a transmitter operable by the computer to transmit to a data collection location said volume measurements and the source identifier and volume value for a release of differing byproducts to a transport vehicle.

15. The apparatus of claim 14, further comprising an automated valve located adjacent to a volume of one or more fossil fuel liquid byproducts among a plurality of fossil fuel liquid byproducts located within a storage container; said automated valve further operable by the computer such that reception of a predetermined code from a storage container user interface opens the automated valve to facilitate the release of a quantity of the one or more byproducts to a transport vehicle.

16. The apparatus of claim 15, the automated valve further having means for being opened manually.

17. The apparatus of claim 16, wherein the computer is programmed to close the valve after the passage of a predetermined time subsequent to opening the valve through manual means.

18. The apparatus of claim 14, further comprising a valve located adjacent to a volume of one or more fossil fuel liquid byproducts among a plurality of fossil fuel liquid byproducts located within a storage container; said valve further including a means for being opened manually.

19. The apparatus of claim 14, the computer further operable for receiving a predetermined code through a storage container user interface to identify an entity initiating the release of a quantity of the one or more byproducts to a transport vehicle.

20. The apparatus of claim 19, the computer further operable to record the code with a corresponding volume value and source identifier for a release; said computer further operable to transmit the code, volume value, and source identifier to a data collection location by using the transmitter.

21. The apparatus of claim 14 the computer and transmitter being enclosed within a fluid and dust impermeable housing adjacent to and outside of the storage container.

22. The apparatus of claim 14, further comprising a solar panel and battery for powering the computer and transmitter.

23. The apparatus of claim 14, further comprising a display in communication with the computer and capable of displaying program steps and modes of the computer's operation.

24. The apparatus of claim 14, further comprising a sensing means for making volume measurements of one or more fossil fuel liquid byproducts among a plurality of fossil fuel liquid byproducts located within a storage container.

25. The apparatus of claim 15, the computer further capable of authorizing predetermined release quantities for the one or more byproducts to a transport vehicle, the predetermined release quantities corresponding to the predetermined code for identifying an entity initiating the release of a quantity of the one or more byproducts to a transport vehicle.

26. An apparatus for fossil fuel liquid byproduct management comprising:
a computer with memory for receiving and recording volume measurements of one or more fossil fuel liquid byproducts among a plurality of fossil fuel liquid byproducts located within a storage container and storing modules for program control and manipulating data in memory; the computer further operable for receiving a predetermined code to identify an entity initiating the release of a quantity of the one or more byproducts to a transport vehicle; the computer further capable of recording a release of a quantity of the one or more byproducts to a transport vehicle with a source identifier, volume value for each of the one or more byproducts corresponding to the release, and the predetermined code;
a transmitter operable by the computer to transmit to a data collection location said volume measurements as well as the predetermined code, volume value, and source identifier for a release of a quantity of the one or more byproducts to a transport vehicle; and
an automated valve located adjacent to a volume of the one or more byproducts within a storage container; said automated valve further operable by the computer such that reception of a predetermined code from a storage container user interface opens the automated valve to facilitate the release of a quantity of the one or more byproducts to a transport vehicle.

27. The apparatus of claim 26, the computer further located at the storage container and capable of optimizing data prior to transmission.

28. The apparatus of claim 26, the computer further capable of authorizing predetermined release quantities for the one or more byproducts to a transport vehicle, the predetermined release quantities corresponding to the predetermined code for identifying an entity initiating the release of a quantity of the one or more byproducts to a transport vehicle.

29. The apparatus of claim 26, the computer further capable of storing the recorded code with a corresponding volume value and source identifier for a release after any transmission of the same to a data collection.

30. The apparatus of claim 26, wherein one or more of the byproducts is from the following group: oil, water, diesel fuel, and condensate.

31. A method for fossil fuel liquid byproduct management comprising:
monitoring a volume of one or more fossil fuel liquid byproducts among a plurality of fossil fuel liquid byproducts located within a storage container using a computer having memory for receiving and recording volume measurements of the one or more byproducts and storing modules for program control and manipulating data in memory;
assigning a volume value for the one or more byproducts and assigning a source identifier to a release of a quantity of one or more byproducts to a transport vehicle by using the computer; and
transmitting the source identifier and volume value to a data collection location by using a transmitter operated by the computer.

32. The method of claim 31, further comprising the step of the computer receiving a predetermined code identifying an entity initiating the release of a quantity of the one or more byproducts to a transport vehicle, and recording and transmitting the code with a corresponding volume value for differing byproducts and a source identifier for a release.

33. The method of claim 32, further comprising the step of opening an automated valve using the computer after the computer receives the code.

34. The method of claim 32, further comprising the step of opening an automated valve using the computer.

35. The method of claim 32, further comprising the step of opening a manual valve.
